(19) United States
(12) Patent Application Publication
(10) Pub. No.: US 2004/0253933 A1
(43) Pub. Date: Dec. 16, 2004

(54) Handyphone having antenna positioned to reduce potential harm to human brain induced by electromagnetic radiation

(76) Inventor: Hao-Jan Ni, Yung-Ho City (TW)

Correspondence Address: Jason Z. Lin, Supreme Patent Services, Post Office Box 2339, Saratoga, CA, 95070-0339, US

(21) Appl. No.: 10/460,863

(22) Filed: Jun. 12, 2003

(51) Int. Cl. H04M 1/00

(52) U.S. Cl. 455/90.3; 455/550.1

(57) ABSTRACT

A handyphone having an antenna positioned to reduce potential harm to human brain induced by electromagnetic radiation is disclosed. The antenna is disposed adjacent to a microphone end of the handyphone instead of an earphone end as done in conventional handyphones in order to space the antenna far apart from the earphone end of the handyphone and accordingly reduce the potential radiation harm to a user's brain.

### BACKGROUND OF THE INVENTION

1. Field of the Invention

The present invention relates generally to the field of wireless handyphone, and more specifically, it relates to an antenna positioned and arranged to reduce radiation harm induced on human brain caused by the operation of the handyphone.

2. The Related Arts

A generic wireless handyphone may serve as a mobile phone or a home-use wireless phone of which the major structure is usually comprised of an earphone, a screen, several function keys, a plurality of number entry keys, and a microphone.

In addition to the major structure, a wireless handyphone also contains an exposed or a built-in antenna. As shown in FIG. 1, a conventional exposed antenna 21 is located adjacent to an earphone 11 of the wireless handyphone.

FIG. 2 shows a built-in antenna of a conventional wireless handyphone, in which a built-in antenna 31 is arranged adjacent to an earphone 11 of the handyphone.

FIG. 3 shows a collapsible structure of a prevailing wireless handyphone, in which an earphone and a microphone are separately and rotatably connected with each other for closing or opening the handyphone by a relative swivel. An exposed or built-in antenna 21 is also provided to the collapsible handyphone. For example, an exposed antenna is positioned close to an earphone 11 as shown in FIG. 3, and a built-in antenna 31 for another style of collapsible handyphone is located also near an earphone 11 as shown in FIG. 4.

As already known, the intensity of electromagnetic radiation decreases in proportion to the square of distance from the source of the radiation. In the case of mobile phone, the radiation source is the antenna. The distance of interest is the distance between the antenna and the brain of a mobile phone user. Thus, attempts have been made to increase the distance between the user's brain and the antenna. Examples include an antenna made extendable through a two part foldover mobile phone disclosed in U.S. Pat. No. 6,505,036, an extendable antenna disclosed in U.S. Pat. No. 5,541,609 and a rotating antenna disclosed in U.S. Pat. No. 5,630,211.

### SUMMARY OF THE INVENTION

A primary object of the present invention is to provide a mobile phone having an antenna positioned to reduce potential damage to human brain caused by electromagnetic radiation wherein the antenna is positioned adjacent to a microphone end of the mobile phone instead of being adjacent to an earphone end, such that the antenna is located far apart from a user's brain to reduce possible radiation harm to the brain.

In accordance with the present invention, an antenna of a mobile phone, either an exposed antenna or a built-in antenna, is positioned adjacent to a microphone end, which is near a user's mouth and away from the brain of the user. As compared to the layout of conventional mobile phones wherein the antenna is located close to the earphone end and thus near the brain of the user, the distance between the antenna and the user's brain for the mobile phone in accordance with the present invention is substantially increased and the electromagnetic radiation intensity to which the user's brain is exposed is reduced whereby the user's brain is better protected from damage caused by the radiation. The novel arrangement of the antenna reduces possible radiation harm while induces no deterioration in communication performance because the mobile phone is basically an omni-directional communication tool. So a user can rotate the mobile phone 180 degrees, making the antenna pointing to the ground, and maintains same communication quality as the antenna pointing up. The present invention alleviates the radiation damage problem by repositioning the antenna at a location far away from the brain thereby reducing the potential damage to the brain, with a minor modification of the circuit of a main board of the phone. And this present invention is more convenient and more user-friendly than previous art works, since it does not require a user to extend or to rotate an antenna before making or picking up every phone call.

Several embodiments of the present invention will be presented, in which an exposed and a built-in antenna are mounted on a microphone end of the mobile phone.

For more detailed information regarding advantages and features of the present invention, the preferred embodiments of the present invention will be described below with reference to the annexed drawings.

### BRIEF DESCRIPTION OF THE DRAWINGS

The related drawings in connection with the detailed description of the present invention to be made later are described briefly as follows, in which:

FIG. 1 is a plan view showing a conventional wireless handyphone having an exposed antenna;

FIG. 2 is a plan view showing a conventional wireless handyphone having a built-in antenna;

FIG. 3 is a perspective view showing a conventional collapsible hnadhyphone having an exposed antenna;

FIG. 4 is a perspective view showing a conventional collapsible handyphone having a built-in antenna;

FIG. 5 is a plan view of a wireless handyphone comprising an exposed antenna in accordance with a first preferred embodiment of the present invention;

FIG. 5A is a side elevational view of the wireless handyphone of the first preferred embodiment of the present invention;

FIG. 6 is a plan view of a wireless handyphone comprising a built-in antenna in accordance with a second embodiment of the present invention;

FIG. 7 is a perspective view showing a collapsible handyphone comprising an exposed antenna in accordance with another embodiment of the present invention; and

FIG. 8 is a perspective view showing a collapsible handyphone comprising a built-in antenna in accordance with a further embodiment of the present invention.

### DETAILED DESCRIPTION OF THE PREFERRED EMBODIMENTS

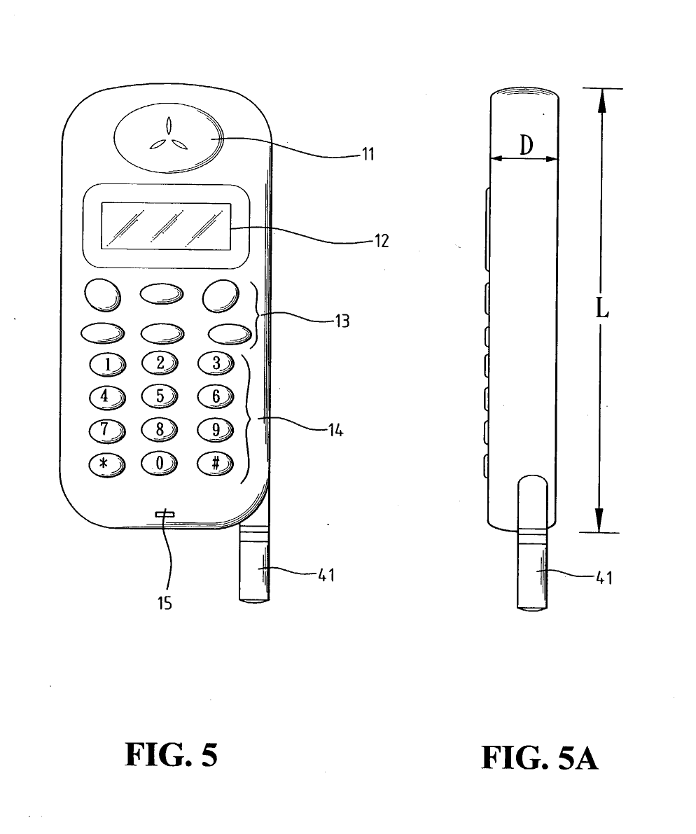

With reference to the drawings and in particular to FIG. 5, a wireless handyphone constructed in accordance with the present invention comprises a body comprised of an earphone 11, a screen 12, a number of function keys 13, a plurality of number entry keys 14, a microphone 15, and an exposed antenna 41 located adjacent to the microphone 15. When a user operates the handyphone, the mouth of the user is close to the exposed antenna 41 and the distance between the antenna 41 and the user's brain is substantially extended.

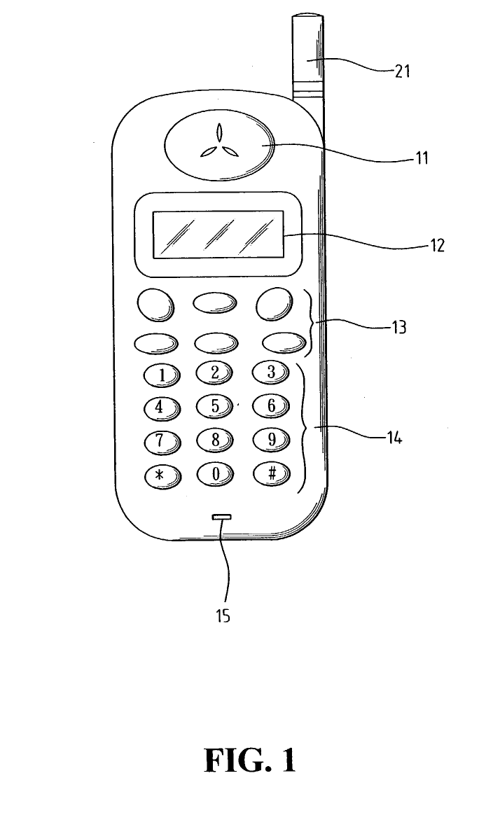

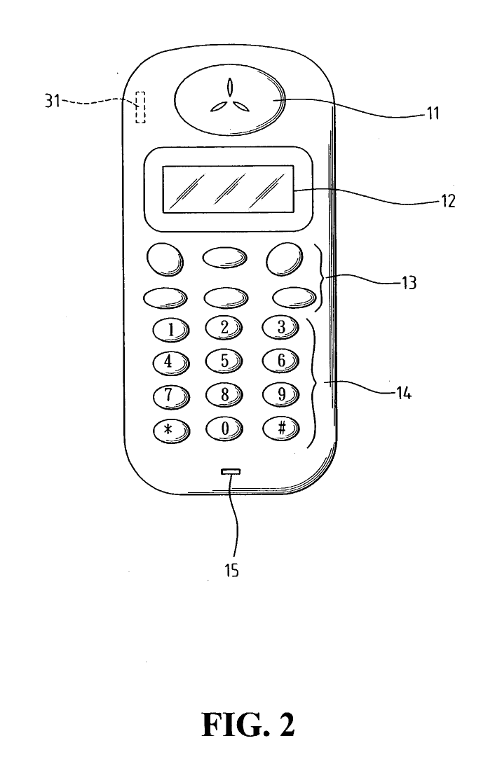

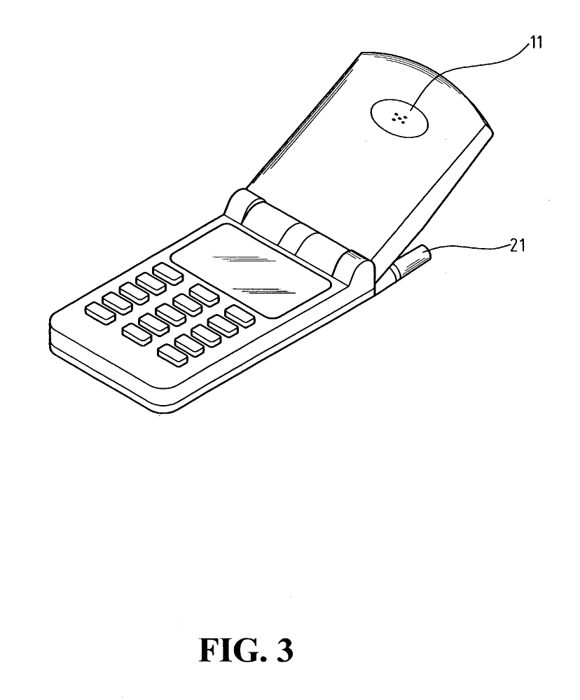

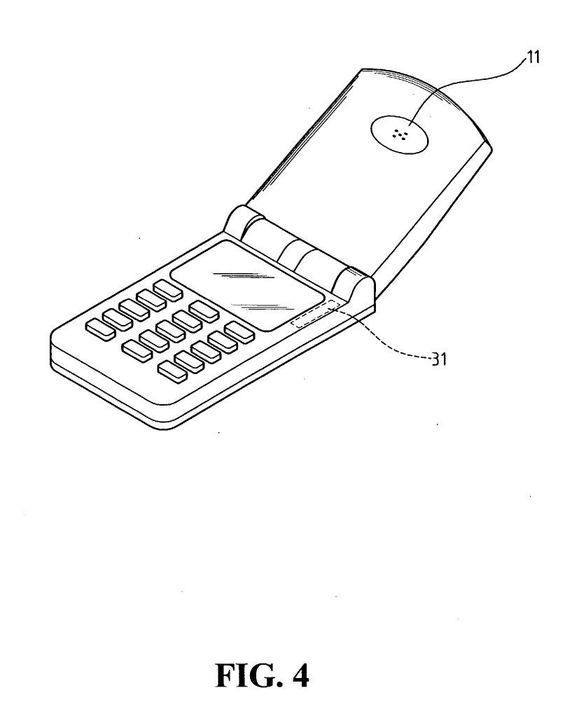

In a conventional handyphone (see FIG. 1), when a user operates the handyphone, the distance between the antenna and the user's brain is approximately 1-2 centimeters, which is roughly the thickness of the handyphone. However, in the handyphone of the present invention, as illustrated in FIG. 5A, the distance between the user's brain and the antenna 41 is increased from the thickness, which is designated with reference character D in FIG. 5A, to the length of the phone, which is designated with reference character L. In a preferred embodiment of the present invention, the length L is approximately 8-10 centimeters. By applying the novel arrangement of the present invention, the distance between a user's brain and the antenna is effectively increased from 1-2 centimeters to 8-10 centimeters whereby the electromagnetic radiation intensity to which the user's brain is exposed is reduced to 6%-1% of the conventional designs.

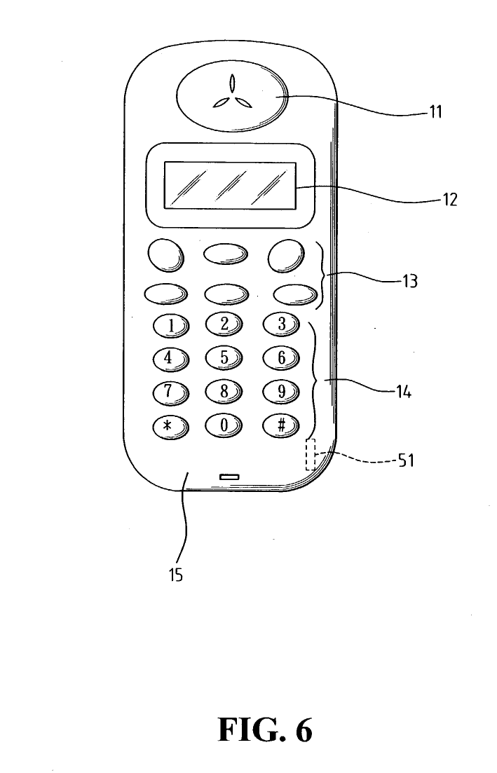

Also referring to FIG. 6, a wireless handyphone constructed in accordance with a second preferred embodiment of the present invention comprises a built-in antenna 51 disposed adjacent to a microphone 15 of the handyphone. When a user operates the handyphone of the second embodiment of the present invention, the mouth of the user is near the built-in antenna 51 while the ear and thus the brain of the user are distant from the antenna. Thus, the potential radiation harm induced on the brain by the radiation of the antenna is significantly reduced.

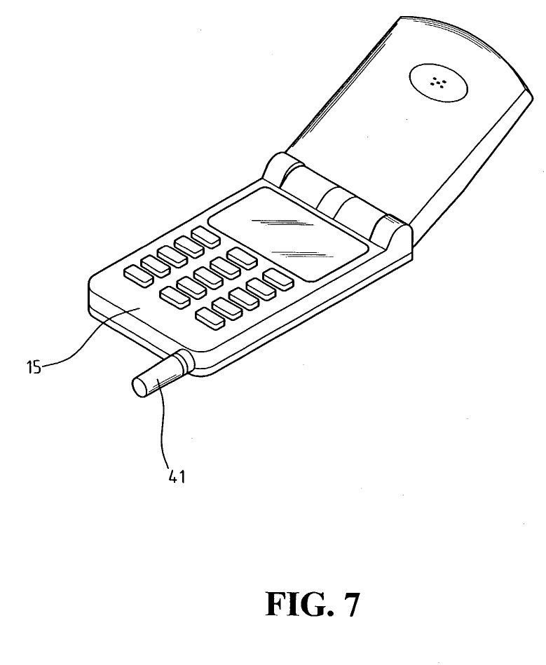

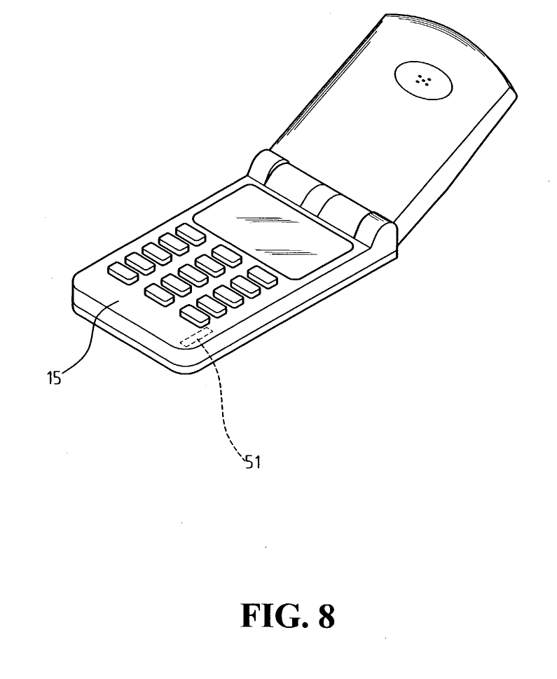

The novel design of the present invention by disposing the antenna 41, 51 near the microphone 15 is also applicable to the structure of a collapsible handyphone as shown in FIGS. 7 and 8.

In short, the highlight of the present invention is to move the antenna from the earphone end to the microphone end of a handyphne and change the layout of the relevant circuits accordingly.

In the above described, the preferred embodiments have been described in detail with reference to the drawings annexed, and it is apparent that numerous changes or modifications may be made without departing from the true spirit and scope thereof, as set forth in the claims below.

What is claimed is:

1. A handyphone comprising an antenna mounted closer to a microphone end than an earphone end.

2. The handyphone according to claim 1, wherein the handyphone comprises a mobile phone.

3. The handyphone according to claim 1, wherein the handyphone comprises a home use wireless phone.

4. The handyphone according to claim 1, wherein the antenna comprises a built-in antenna.

5. The handyphone according to claim 1, wherein the antenna comprises an exposed antenna.

6. The handyphone according to claim 1, wherein the handyphone comprises a non-collapsible phone.

7. The handyphone according to claim 1, wherein the handyphone comprises a collapsible phone.
